(19) United States
(12) Patent Application Publication
(10) Pub. No.: US 2008/0089359 A1
(43) Pub. Date: Apr. 17, 2008

(54) PORTABLE INTERNET SERVICE SYSTEM AND METHOD

(75) Inventors: Chee-hwan YANG, Suwon-si (KR); Cheon-moo Lee, Yongin-si (KR); Youne-sang Lee, Suwon-si (KR); Hyun-woo Lee, Suwon-si (KR); Man-sung Ko, Suwon-si (KR); Bum-hee Seo, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/775,296

(22) Filed: Jul. 10, 2007

(30) Foreign Application Priority Data
Oct. 16, 2006 (KR) 2006-100329

(51) Int. Cl. H04J 3/16

(52) U.S. Cl. 370/469

(57) ABSTRACT

A portable Internet service system includes a plurality of terminals which transmit uplink data for performing wireless communication; and a base station which receives the uplink data from the plurality of terminals, transmits downlink data to the plurality of terminals, and establishes a peer-to-peer function to perform a peer-to-peer transmission between the plurality of terminals.

### CROSS-REFERENCE TO RELATED APPLICATIONS

This application claims all benefits accruing under 35 U.S.C. §119 from Korean Patent Application No. 2006-100329, filed on Oct. 16, 2006 in the Korean Intellectual Property Office, the disclosure of which is incorporated herein by reference.

### BACKGROUND OF THE INVENTION

1. Field of the Invention

Aspects of the present invention relate to a portable Internet service system and a method thereof and, more particularly, to a portable Internet service system to perform a peer to peer transmission to increase wireless transmission efficiency in a network and a method thereof.

2. Related Art

Using portable Internet services, a user may wirelessly access the Internet at a high speed using a portable terminal while in motion or remaining stationary at a designated location. Portable Internet services are provided to support a seamless wireless Internet access in both indoor and outdoor environments regardless of whether the user is moving or standing still. The Wireless Broadband (WiBro) standard and the World Interoperability for Microwave Access (WiMAX) standard have been suggested as potential portable Internet service standards. Data transmission between a base station and a portable terminal is defined in the IEEE 802.16e standard for the portable internet, including WiBro and WiMAX. Since the standards require uplink data and downlink data to be transmitted through the base station when they are transmitted between terminals within a predetermined area, a wireless network transmission band may be used wastefully.

### SUMMARY OF THE INVENTION

Aspects of the present invention provide a portable Internet service system to perform a peer-to-peer transmission to increase network wireless transmission efficiency and a method thereof.

Another aspect of the present invention provides a portable Internet service system to optimize network transmission efficiency by omitting additional downlink data transmission process from an uplink data transmission operation.

Additional aspects and/or advantages of the invention will be set forth in part in the description which follows and, in part, will be obvious from the description, or may be learned by practice of the invention.

According to an aspect of the present invention, a portable Internet service system is provided, with a plurality of terminals transmitting uplink data to perform wireless communication; and a base station to receive the uplink data from the plurality of terminals, to transmit downlink data to the plurality of terminals, and to establish a peer-to-peer function to perform a peer-to-peer transmission between the plurality of terminals.

According to another aspect of the present invention, the base station transmits a control signal to a transmitting terminal of the plurality of terminals so that the transmitting terminal transmits the uplink data, and the base station transmits the control signal to a receiving terminal of the plurality of terminals so that the receiving terminal receives the uplink data from the transmitting terminal.

According to another aspect of the present invention, the base station transmits a peer-to-peer receiving control signal to the receiving terminal so that the receiving terminal receives the uplink data from the transmitting terminal, and the receiving terminal receives the peer-to-peer receiving control signal and establishes a parameter to receive the uplink data from the transmitting terminal.

According to another aspect of the present invention, the receiving terminal and the base station concurrently receive the uplink data from the transmitting terminal.

According to another aspect of the present invention, the receiving terminal notifies the base station of an uplink data receiving error when the receiving terminal does not receive the uplink data from the transmitting terminal.

According to another aspect of the present invention, the receiving terminal transmits a transmission request signal, which requests the downlink data for the uplink data received by the base station, to the base station when the receiving terminal does not receive the uplink data from the transmitting terminal.

According to another aspect of the present invention, the base station transmits the uplink data received from the transmitting terminal to the receiving terminal as the downlink data, according to the transmission request signal received from the receiving terminal.

According to another aspect of the present invention, the base station determines whether the uplink data transmitted from the transmitting terminal is to be received to the receiving terminal in a peer-to-peer fashion.

According to another aspect of the present invention, the base station determines whether the transmitting and receiving terminals are positioned within an area in which the transmitting and receiving terminals are to receive data in the peer-to-peer fashion.

According to another of the present invention, the base station determines whether the receiving terminal is to receive data in the peer-to-peer fashion.

According to another aspect of the present invention, a portable Internet service method is provided, comprising requesting a base station to transmit data stored in a first terminal; and establishing a peer-to-peer function in the first terminal and a second terminal so that peer-to-peer transmitting and receiving operations are performed between the first and second terminals.

According to another aspect of the present invention, the establishing of the peer-to-peer function comprises, transmitting a control signal to the first terminal so that the first terminal transmits uplink data, and transmitting the control signal to the second terminal so that the second terminal receives the uplink data from the first terminal.

According to another aspect of the present invention, the establishing of the peer-to-peer function comprises: transmitting a peer-to-peer receiving control signal to the second terminal so that the second terminal receives the uplink data from the first terminal; and receiving the peer-to-peer receiving control signal and establishing a parameter so that the second terminal receives the uplink data from the first terminal.

According to another aspect of the present invention, the portable Internet service method further comprises receiving the uplink data from the first terminal concurrently at the base station and the second terminal.

According to another aspect of the present invention, the portable Internet service method further comprises notifying the base station of an uplink data receiving error when the second terminal does not receive the uplink data from the first terminal.

According to another aspect of the present invention, the notifying of the uplink data receiving error comprises requesting downlink data for the uplink data received from the base station.

According to another aspect of the present invention, the portable Internet service method further comprises transmitting the uplink data received from the first terminal to the second terminal as the downlink data according to a downlink data request of the second terminal.

According to another aspect of the present invention, the portable Internet service method further comprises determining whether the uplink data transmitted from the first terminal is to be received to the second terminal in a peer-to-peer fashion.

According to another aspect of the present invention, the determining of whether the uplink data is to be received in the peer-to-peer fashion comprises determining whether the first and second terminals are positioned within an area in which the first and second transmitting terminals are to receive data in the peer-to-peer fashion.

According to another aspect of the present invention, the determining of whether the uplink data is to be received in the peer-to-peer fashion comprises determining whether the second terminal is to receive data in the peer-to-peer fashion.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 shows a portable Internet service system according to an example embodiment of the present invention;

FIG. 2 shows a transmission frame configuration of the portable Internet service system according to an example embodiment of the present invention;

FIG. 3 shows a hierarchical structure of the portable Internet service system according to an example embodiment of the present invention;

FIG. 4 shows a flowchart representing a transmission routine of the portable Internet system according to an example embodiment of the present invention;

FIG. 5A and FIG. 5B respectively show schematic diagrams representing a peer to peer transmission routine of the portable Internet service system according to an example embodiment of the present invention; and

FIG. 6 shows a schematic diagram of a connection structure of transmitting and receiving terminals according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

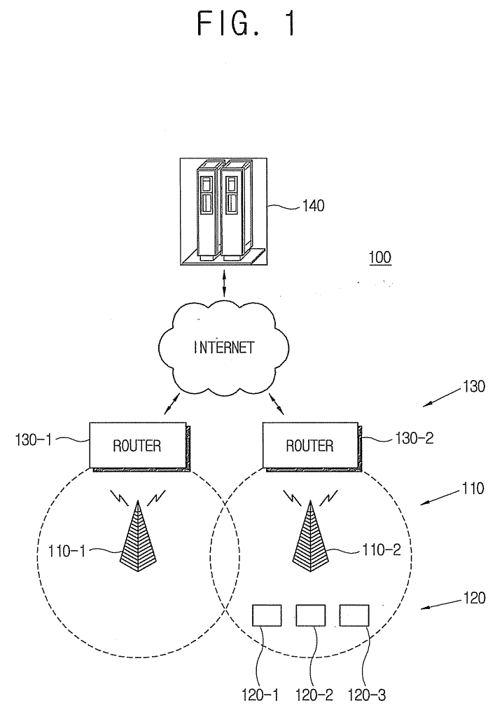

FIG. 1 shows a schematic diagram of the portable Internet service system according to an example embodiment of the present invention. The portable Internet service system 100 includes a base station 110, a portable terminal 120 to perform a wireless communication with the base station 110, a router 130 to wirelessly connect the base station 110 with the portable terminal 120, and a server 140. Although FIG. 1 shows two routers 130 and three portable terminals 120, the portable Internet system may have any number of routers 130 and portable terminals 120. The portable terminal 120 may be any portable device, such as a notebook computer, a mobile phone, a personal digital assistant (PDA), a personal entertainment device, a multi-function device, etc.

In the portable Internet service system 100, a data communication service guaranteeing mobility may be provided even when the portable terminal 120 moves from a cell covered by a base station 110-1 to another cell covered by another base station 110-2. Similar to a mobile communication service, the portable Internet service system 100 supports a handover of the portable terminal 120 and allocates a dynamic Internet protocol (IP) address according to the movement of the portable terminal 120.

The base station 110-2 and a plurality of portable terminals 120-1, 120-2, and 120-3 communicate with each other in an orthogonal frequency division multiplexing access (OFDMA) method. The OFDMA method is a multiplexing method in which a frequency division method using subcarriers of a plurality of orthogonal frequencies as a plurality of subchannels and a time division multiplexing access (TDMA) method are combined. The OFDMA method is robust against multi-path fading and has a high data rate. However, other communication methods may also be employed, including code division multiple access (CDMA) and TDMA.

The IEEE 802.16e standard employs an adaptive modulation and coding (AMC) method that adaptively selects modulation and coding according to a channel state and a location of the portable terminal 120 to provide an appropriate data rate. Accordingly, when a plurality of users share a given capacity, transmission speed varies according to predetermined environments (i.e., a load of neighboring cells and a current channel state of a subscriber). However, aspects of the present invention may employ different standards, such as IEEE 802.11 or Bluetooth.

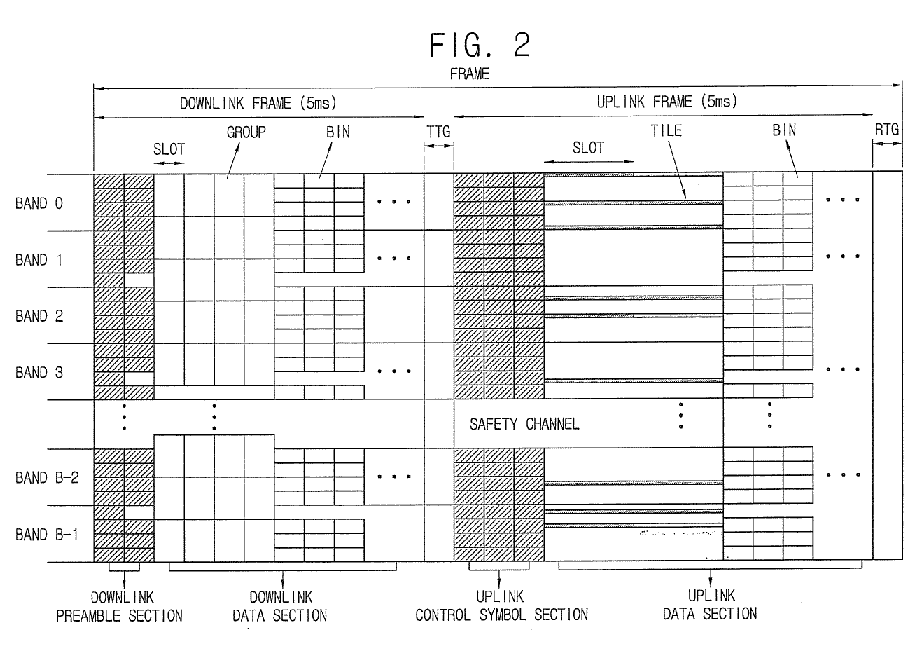

FIG. 2 shows a frame configuration of the portable Internet service system 100 according to an example embodiment of the present invention. A transmission frame of the portable Internet service system 100 includes an uplink frame and a downlink frame. The uplink frame and the downlink frame respectively have fixed time values of 5 ms as shown in FIG. 2.

The uplink frame includes an uplink control symbol and uplink data. The uplink data includes a slot, a tile, and a bin. A receive-to-transmit transition gap (RTG) of 40.4 ms is provided at an end part of the uplink frame as a guard time to divide uplink and downlink frame transmission times. The downlink frame includes a downlink preamble and downlink data. Like the uplink data, the downlink data also includes a slot, a group, and a bin. A transmit-to-receive transition gap (TTG) of 121.2 ms is provided at an end part of the downlink frame as the guard time to divide the uplink and downlink frame transmission times.

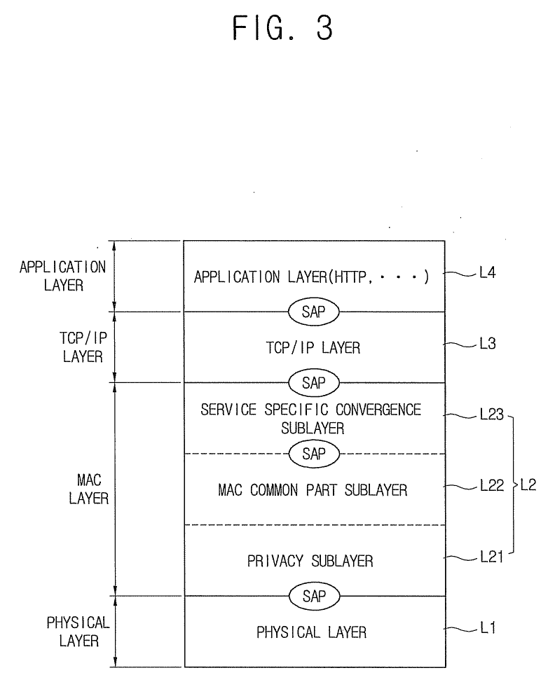

FIG. 3 shows a hierarchical structure of the portable Internet service system according to an example embodiment of the present invention. The hierarchical structure of the portable Internet service system using the IEEE 802.16e standard comprises a physical layer L1, a media access control (MAC) layer L2, a transmission control protocol (TCP)/IP layer L3, and an application layer L4. Other layers may be present as well, such as the seven layers of the OSI model.

The physical layer L1 performs a wireless communication function that is performed by a conventional physical layer. The wireless communication function includes modulation/demodulation and coding functions. In addition, the physical layer L1 includes a modem to convert and to protect data in the wireless environment, as well as a transmitting/receiving unit including a radio frequency (RF) unit to wirelessly transmit and receive data.

The MAC layer L2 may include a privacy sublayer L21, a MAC common part sublayer L22, and a service specific convergence sublayer L23. The privacy sublayer L21 performs authentication, security key exchange, and encryption functions for the portable terminal 120. The authentication function of the portable terminal 120 is performed in the privacy sublayer L21 and a user authentication function is performed in an upper layer (not shown). The MAC common part sublayer L22, which is a core part of the MAC layer, performs functions relating to system access, bandwidth allocation, and connection establishment and management operations. The service specific convergence sublayer L23 performs payload header suppression and quality of service (QoS) mapping functions for sequential data communication.

The TCP/IP layer L3 connects each system and uses the TCP protocol to perform a data transmission function. The application layer L4 includes an application program using the network, such as HyperText Transfer Protocol (HTTP) for web browsing.

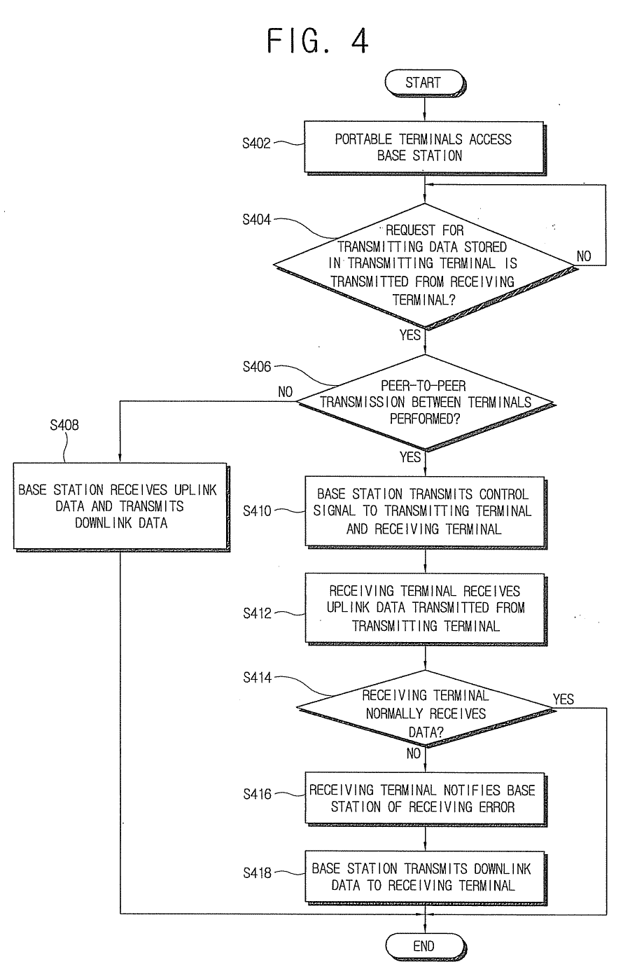

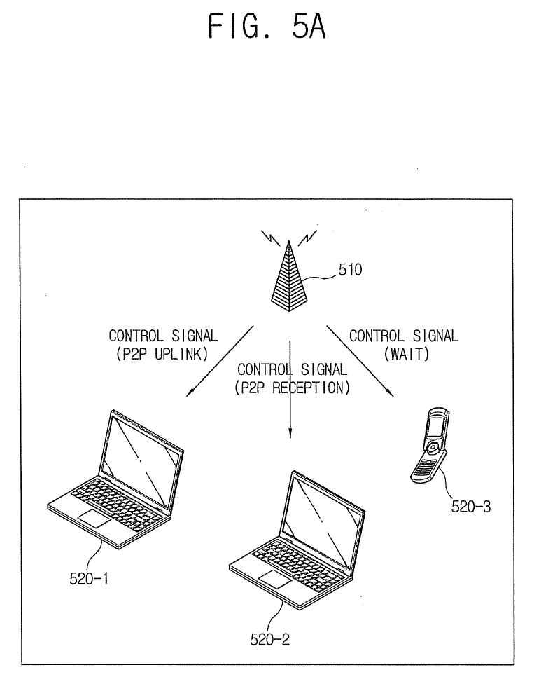

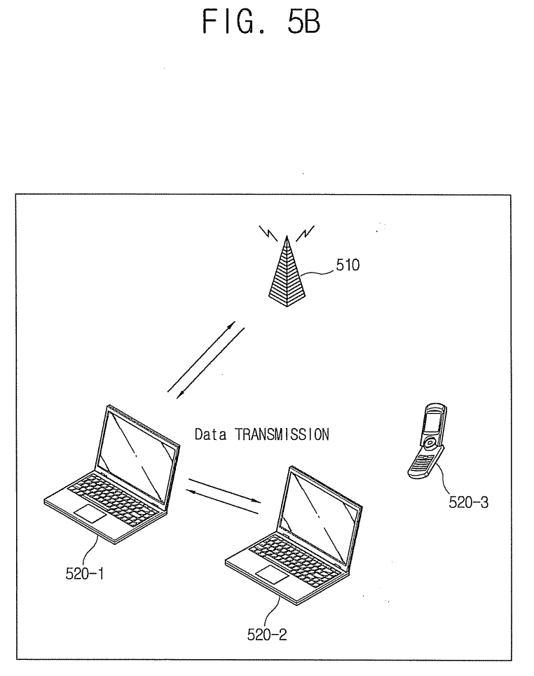

FIG. 4 shows a flowchart of a transmission routine of the portable Internet system according to an example embodiment of the present invention. FIG. 5A and FIG. 5B, respectively, show a peer to peer transmission routine of the portable Internet service system 100 according to an example embodiment of the present invention.

The plurality of portable terminals 520-1, 520-2, and 520-3 access the base station 510 at block S402. When power is supplied to a first portable terminal 520-1, or the first portable terminal 520-1 enters a cell of the base station 510, the base station 510 establishes a downlink synchronization with the first portable terminal 520-1. Once the downlink synchronization is established, the first portable terminal 520-1 obtains an uplink parameter and a ranging operation is performed between the first portable terminal 520-1 and the base station 510. In addition, access control functions, including authentication, registration, address allocation, and traffic connection establishment and change, are performed in order for the first portable terminal 520-1 to access the portable Internet service.

When a second portable terminal 520-2 (hereinafter referred to as a “receiving terminal”) transmits a download request to download data stored in the first portable terminal 520-1 (hereinafter referred to as a “transmitting terminal”) at block S404, the base station 510 determines at block S406 whether uplink data transmitted from the transmitting terminal 520-1 is received by the receiving terminal 520-2 in a peer-to-peer fashion. The base station 510 determines whether the transmitting terminal 520-1 and the receiving terminal 520-2 are positioned within an area of the base station 510 and determines whether the transmitting terminal 520-1 and the receiving terminal 520-2 are positioned within an area in which the transmitting terminal 520-1 and the receiving terminal 520-2 may receive data in the peer-to-peer method. While the first portable terminal 520-1 is a transmitting terminal and the second portable terminal 520-2 is a receiving terminal, it is understood that according to other aspects of the invention, the first and second portable terminals 520-1 and 520-2 may perform both transmitting and receiving functions.

When the receiving terminal 520-2 has a parameter different from an existing parameter to perform a peer-to-peer function, the base station 510 determines whether the receiving terminal 520-2 may receive the data in the peer-to-peer method. If peer-to-peer transmission may not be performed between the transmitting terminal 520-1 and the receiving terminal 520-2, the base station 510 receives the uplink data from the transmitting terminal 520-1, adds the uplink data to the downlink frame, and transmits the downlink frame to the receiving terminal 520-2 at block S408. If the peer-to-peer transmission may be performed between the transmitting terminal 520-1 and the receiving terminal 520-2, the base station 510 transmits a control signal to the transmitting terminal 520-1 so that the transmitting terminal 520-1 transmits the uplink data. The base station 510 transmits a control signal to the receiving terminal 520-2 to receive the uplink data from the transmitting terminal 520-1 at block S410.

As shown in FIG. 5A, the base station 510 transmits a peer-to-peer uplink control signal to the transmitting terminal 520-1 and transmits a peer-to-peer receiving control signal to the receiving terminal 520-2. An area of the uplink data is defined in the peer-to-peer uplink control signal transmitted to the transmitting terminal 520-1. Information for notifying the uplink data area transmitted from the transmitting terminal 520-1 is defined in the peer-to-peer receiving control signal transmitted from the receiving terminal 520-2. Accordingly, the transmitting terminal 520-1 prepares to transmit the data and the receiving terminal 520-2 establishes an internal parameter to receive the uplink data from the transmitting terminal 520-1. Returning to FIG. 4, the transmitting terminal 520-1 transmits the uplink data to the base station 510 and the receiving terminal 520-2 and the receiving terminal 520-2 and the base station 510 concurrently receive the uplink data from the transmitting terminal 520-1 at block S412.

As shown in FIG. 5B, the transmitting terminal 520-1 transmits the uplink data and the base station 510 and the receiving terminal 520-2 concurrently receive the uplink data from the transmitting terminal 520-1. Accordingly, the base station 510 is not required to transmit the uplink data received from the transmitting terminal 520-1 to the receiving terminal 520-2 as downlink data. Since the receiving terminal 520-2 concurrently receives the uplink data transmitted from the transmitting terminal 520-1 to the base station 510, the base station 510 is not required to transmit the downlink data to the receiving terminal 520-2. The downlink band may instead be used for another portable terminal.

Returning to FIG. 4, if the receiving terminal 520-2 does not receive the uplink data from the transmitting terminal 520-1 normally at block S414, the receiving terminal 520-2 notifies the base station 510 of an uplink data receiving error at block S416. If an error rate of the uplink data received in the receiving terminal 520-2 is greater than a predetermined rate, the receiving terminal 520-2 may notify the base station of the uplink data receiving error and receive the uplink data again. The receiving terminal 520-2 may request the downlink data for the uplink data received in the base station 510. The base station 510 transmits the uplink data received from the transmitting terminal 520-1 to the receiving terminal 520-2 as the downlink data according to a transmission request signal received from the receiving terminal 520-2 at block S418.

If the receiving terminal 520-2 continuously receives the data from the transmitting terminal 520-1, an exclusive channel may be formed. The base station 510 may repeat block S410 and transmit the control signal to the transmitting terminal 520-1 and the receiving terminal 520-2.

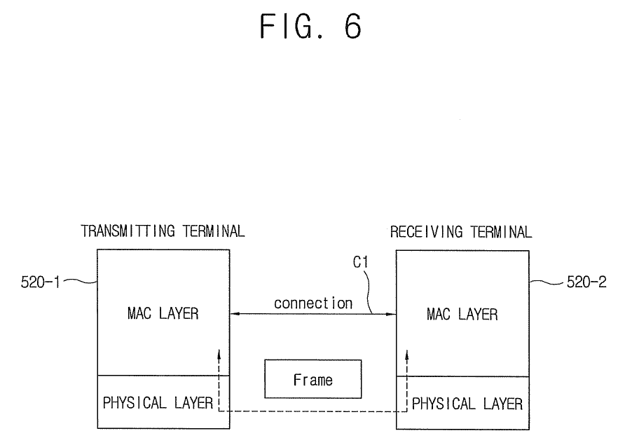

FIG. 6 shows a schematic diagram of a connection structure of the transmitting and receiving terminals according to an example embodiment of the present invention. The base station 510 transmits the control signal to the transmitting terminal 520-1 so that the transmitting terminal 520-1 transmits the uplink data. The base station 510 transmits the control signal to the receiving terminal 520-2 so that the receiving terminal 520-2 receives the uplink data from the transmitting terminal 520-1. In addition, the transmitting terminal 520-1 and the receiving terminal 520-2 receive the control signal from the base station 510 and establish a parameter for performing the peer-to-peer function. In this fashion, a connection C1 is created between the MAC layer of the transmitting terminal 520-1 and the MAC layer of the receiving terminal 520-2.

The connection C1 is not a physical connection relationship but a logical connection relationship. The connection C1 may be defined as a mapping relationship between MAC peer layers of the transmitting and receiving terminals 520-1 and 520-2 to transmit traffic of one service flow. A parameter or a message defined on the connection C1 defines a function between the MAC peer layers. The parameter or the message is formed as a frame to be transmitted through the physical layer and the frame is analyzed so that the MAC layer performs a function corresponding to the parameter or the message.

In the example embodiment of the present invention as shown in FIG. 6, the base station 510 may establish the connection of the transmitting terminal 520-1 and the receiving terminal 520-2 to have a bidirectional characteristic.

As described above, according to aspects of the present invention, a peer-to-peer transmission to increase wireless transmission efficiency of a network may be performed.

In addition, since a downlink data transmission process additionally caused by uplink data transmission is omitted, the transmission efficiency of the network may be maximized.

Peer-to-peer transmission routines according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the base station 110 may comprise a receiving unit to receive the uplink signals from the transmitting terminal 520-1, a transmission unit to transmit downlink data and control signals to the transmitting terminal 520-1 and the receiving terminal 520-2, and a controller to establish the peer-to-peer communication between the transmitting terminal 520-1 and the receiving terminal 520-2. Similarly, the transmitting and receiving terminals 520-1 and 520-2 may comprise communication units to communicate with the other terminal and with the base station as well as a controller to establish the peer-to-peer communication. The base station 110, transmitting terminal 520-1, and receiving terminal 520-2 may comprise other components. The functionality of one or more of the above components may also be combined into a single component. Accordingly, it is intended, therefore, that the present invention not be limited to the various example embodiments disclosed, but that the present invention includes all embodiments falling within the scope of the appended claims.

What is claimed is:

1. A portable Internet service system comprising:
a plurality of terminals transmitting uplink data to perform wireless communication; and
a base station to receive the uplink data from the plurality of terminals, to transmit downlink data to the plurality of terminals, and to establish a peer-to-peer function to perform a peer-to-peer transmission between the plurality of terminals.

2. The portable Internet service system of claim 1, wherein:
the base station transmits a control signal to a transmitting terminal of the plurality of terminals so that the transmitting terminal transmits the uplink data; and
the base station transmits the control signal to a receiving terminal of the plurality of terminals so that the receiving terminal receives the uplink data from the transmitting terminal.

3. The portable Internet service system of claim 1, wherein:
the base station transmits a peer-to-peer receiving control signal to the receiving terminal so that the receiving terminal receives the uplink data from the transmitting terminal; and
the receiving terminal receives the peer-to-peer receiving control signal and establishes a parameter to receive the uplink data from the transmitting terminal.

4. The portable Internet service system of claim 1, wherein the receiving terminal and the base station concurrently receive the uplink data from the transmitting terminal.

5. The portable Internet service system of claim 4, wherein the receiving terminal notifies the base station of an uplink data receiving error when the receiving terminal does not receive the uplink data from the transmitting terminal.

6. The portable Internet service system of claim 5, wherein the receiving terminal transmits a transmission request signal, which requests the downlink data for the uplink data received by the base station, to the base station when the receiving terminal does not receive the uplink data from the transmitting terminal.

7. The portable Internet service system of claim 6, wherein the base station transmits the uplink data received from the transmitting terminal to the receiving terminal as the downlink data, according to the transmission request signal received from the receiving terminal.

8. The portable Internet service system of claim 1, wherein the base station determines whether the uplink data transmitted from the transmitting terminal is to be received at the receiving terminal in a peer-to-peer fashion.

9. The portable Internet service system of claim 8, wherein the base station determines whether the transmitting and receiving terminals are positioned within an area in which the transmitting and receiving terminals are to receive data in the peer-to-peer fashion.

10. The portable Internet service system of claim 8, wherein the base station determines whether the receiving terminal is to receive data in the peer-to-peer fashion.

11. A portable Internet service method comprising:
requesting a base station to transmit data stored in a first terminal, at a second terminal; and
establishing, at a base station, a peer-to-peer function in the first terminal and the second terminal so that peer-to-peer transmitting and receiving operations are performed between the first and second terminals.

12. The portable Internet service method of claim 11, wherein the establishing of the peer-to-peer function comprises:
transmitting, at the base station, a control signal to the first terminal so that the first terminal transmits uplink data; and
transmitting, at the base station, the control signal to the second terminal so that the second terminal receives the uplink data from the first terminal.

13. The portable Internet service method of claim 12, wherein the establishing of the peer-to-peer function comprises:
transmitting, at the base station, a peer-to-peer receiving control signal to the second terminal so that the second terminal receives the uplink data from the first terminal; and
receiving, at the second terminal, the peer-to-peer receiving control signal and establishing a parameter so as to receive the uplink data from the first terminal.

14. The portable Internet service method of claim 12, further comprising receiving the uplink data from the first terminal concurrently at the base station and the second terminal.

15. The portable Internet service method of claim 14, further comprising notifying the base station of an uplink data receiving error when the second terminal does not receive the uplink data from the first terminal.

16. The portable Internet service method of claim 15, wherein the notifying of the uplink data receiving error comprises requesting downlink data for the uplink data received from the base station.

17. The portable Internet service method of claim 16, further comprising transmitting, at the base station, the uplink data received from the first terminal to the second terminal as the downlink data according to a downlink data request of the second terminal.

18. The portable Internet service method of claim 11, further comprising determining whether the uplink data transmitted from the first terminal is to be received to the second terminal in a peer-to-peer fashion.

19. The portable Internet service method of claim 18, wherein the determining of whether the uplink data is to be received in the peer-to-peer fashion comprises determining whether the first and second terminals are positioned within an area in which the first and second terminals are to receive data in the peer-to-peer fashion.

20. The portable Internet service method of claim 18, wherein the determining of whether the uplink data is to be received in the peer-to-peer fashion comprises determining whether the second terminal is to receive data in the peer-to-peer fashion.

21. A base station supporting a portable Internet service for a transmitting terminal and a receiving terminal, the base station comprising:
a reception unit to receive uplink signals from the transmitting terminal;
a transmission unit to transmit downlink data to the transmitting terminal; and
a controller to establish a peer-to-peer communication between the transmitting terminal and the receiving terminal using the uplink signals received from the reception unit and the downlink data transmitted by the transmission unit.

22. A portable device comprising:
a communication unit to transmit uplink data to a base station, to receive, in response to the transmission of the uplink data, a peer-to-peer control signal from the base station that is used to establish a peer-to-peer communication with a receiving device, and to communicate with the receiving device using the peer-to-peer communication;
a controller to establish the peer-to-peer communication with the receiving device using the peer-to-peer control signal received by the communication unit.

23. A portable device comprising:
a communication unit to transmit a download request to a base station, to receive a peer-to-peer control signal from the base station in response to the download request, and to communicate with a transmission device in a peer-to-peer communication; and
a controller to establish the peer-to-peer communication with the transmission device using the peer-to-peer control signal received by the communication unit.

24. A method to establish a peer-to-peer communication between a transmitting terminal and a receiving terminal in a portable Internet service system, the method comprising:
receiving a download request from the receiving terminal to download data from the transmitting terminal;
transmitting a control signal based on the download request to the transmitting terminal requesting uplink data from the transmitting terminal; and
transmitting a peer-to-peer uplink control signal to the transmitting terminal and transmitting a peer-to-peer receiving control signal to the receiving terminal;
wherein the peer-to-peer uplink control signal and the peer-to-peer receiving control signal are used to establish a peer-to-peer communication between the transmitting terminal and the receiving terminal so that the receiving terminal can download data from the transmitting terminal directly.

25. The portable Internet system of claim 1, wherein the base station comprises:
a reception unit to receive uplink signals from a transmitting terminal of the plurality of terminals;
a transmission unit to transmit downlink data to the transmitting terminal; and
a controller to establish a peer-to-peer communication between the transmitting terminal and a receiving terminal of the plurality of terminals, using the uplink signals received from the reception unit and the downlink data transmitted by the transmission unit.

26. The portable Internet system of claim 1, wherein the plurality of terminals includes a transmitting terminal comprising:
a communication unit to transmit uplink data to the base station, to receive, in response to the transmission of the uplink data, a peer-to-peer control signal from the base station that is used to establish a peer-to-peer communication with a receiving terminal of the plurality of terminals, and to communicate with the receiving terminal using the peer-to-peer communication;
a controller to establish the peer-to-peer communication with the receiving terminal using the peer-to-peer control signal received by the communication unit.

27. The portable Internet system of claim 1, wherein the plurality of terminals includes a receiving terminal comprising:
a communication unit to transmit a download request to the base station, to receive a peer-to-peer control signal from the base station in response to the download request, and to communicate with a transmitting terminal of the plurality of terminals in a peer-to-peer communication; and
a controller to establish the peer-to-peer communication with the transmitting terminal using the peer-to-peer control signal received by the communication unit.

28. The method according to claim 11, wherein the portable Internet service supports the IEEE 802.16 standard.

29. The method according to claim 28, wherein the portable Internet service is Wireless Broadband (WiBro).

30. The method according to claim 28, wherein the portable Internet service is World Interoperability for Microwave Access (WiMAX).
